(19) United States
(12) Patent Application Publication
(10) Pub. No.: US 2004/0071806 A1
(43) Pub. Date: Apr. 15, 2004

(54) Self cleaning injection molding pin

(76) Inventor: Ronald Thomas, Chesterfield Twp., MI (US)

Correspondence Address: Robert A. Dunn, Dinnin & Dunn, P.C., Suite 500, 2701 Cambridge Court, Auburn Hills, MI, 48326, US

(21) Appl. No.: 10/269,282

(22) Filed: Oct. 11, 2002

(51) Int. Cl. B29C 45/23

(52) U.S. Cl. 425/130; 264/572

(57) ABSTRACT

A self cleaning pin for a fluid assisted injection molding apparatus that includes a pin body with a fluid passage and a shaft member. The shaft member is positioned in the pin, and is reciprocable between a retracted position and an extended position, wherein reciprocation of the pin drives intruding plastic from the end of the pin body. In its retracted position, a tip portion rests against a substantially mating seat, and provides continuous fluid communication between the fluid passage and a mold cavity. The pin also provides adjustable biasing means, the biasing means continuously biasing the pin toward its retracted position. A shaped recess is included in the end of the shaft member, and can be utilized to manually rotate the pin relative to a tensioning member threadedly received on the shaft member, thereby adjusting the biasing force.

### TECHNICAL FIELD

The present invention relates generally to a pin for a fluid-assisted injection molding apparatus, and more particularly to such a pin that is self cleaning.

### BACKGROUND OF THE INVENTION

Fluid-assisted injection molding of plastic parts has long been known in the industry. In short, molten plastic is forced into an enclosed mold, and fluid is injected into the mold within the plastic material. The fluid raises the internal mold pressure, and creates an expanding fluid pocket, which forces the cooling plastic to the extreme recesses of the mold, yielding a better fill out of the mold surface and reducing the sag of the plastic from the mold surface as the plastic shrinks during cooling, thus producing a better finished surface. The fluid also creates an internal cavity within the molded part, which reduces the weight of the part and reduces the amount of plastic required, thus reducing material cost.

There are numerous methods and apparatuses for injecting fluid into a mold, and a variety of factors drive design decisions. For instance, it may be desirable to inject the fluid at varying pressure, mandating particular designs for the valving and fluid delivery system. Additionally, the fluid may be injected through the plastic injection nozzle itself, or it may be injected remotely. Remote fluid injection locations include injecting directly into the mold cavity (in article) or into a channel leading into the mold (in-runner). Due to the higher fluid pressures generally required for dual plastic/fluid injection nozzles, and the associated expense for valving for the resin and fluid flows, the injection of fluid remotely is generally preferred.

Nozzles for use in in-article or in-runner remote fluid injection devices can be subjected to packing by the molten plastic injected into the mold. Fluid injection nozzles are typically located near the plastic injection nozzle so that the fluid injected can best assist the flow of the plastic material throughout its flow through the mold. In such an arrangement, however, the fluid injection nozzle is typically subjected to the flow of molten plastic at its least viscous liquid state and highest pressure, giving it a tendency to clog or pack fluid injection nozzles. A further confounding circumstance is that fluid injection nozzles may be used as fluid exhaust outlets, so that any molten material has a tendency to flow toward and into the outlet during the venting process. As a result, a hardened plastic plug can be left in the fluid outlet, or can even be driven deeper into the fluid injection system to more sensitive and less accessible areas of the equipment. Such plugs are typically removed manually by disassembling the equipment, often a costly and time-intensive endeavor.

### SUMMARY OF THE INVENTION

The present invention is a pin for a fluid assisted injection molding apparatus. The pin provides a pin body with a discharge end having a seat, and a base end. A fluid passage and a shaft member are located in the pin body. The shaft member has a shank portion and a tip portion, and is reciprocable in the pin body between an extended position and a retracted position at which the shaft member and seat define at least one orifice in fluid communication with the fluid passage. A tensioning member is provided and positioned on the shank portion. The pin further provides a biasing member positioned between the tensioning member and the base end, which biases the shaft member toward its retracted position with an adjustable biasing force. Rotation of the shaft member relative to the tensioning member in a first direction compresses the biasing member, while rotation of the shaft member relative to the tensioning member in a second direction decompresses the biasing member.

In another aspect, a pin for a fluid assisted injection molding apparatus is provided. The pin comprises a pin body having an outlet, and a shaft member reciprocable in the pin body between a retracted and an extended position. The shaft member has a tip portion with a shaped recess located in an end face. A tensioning member is provided and is threadedly received on the shaft member and rotatably fixed relative to the pin body. A biasing member is positioned between the pin body and the tensioning member and biases the shaft member toward its retracted position with an adjustable biasing force. The shaft member is rotatable relative to the tensioning member in alternate directions, the rotation facilitated by engagement of the shaped recess with a complementary tool.

### BRIEF DESCRIPTION OF THE DRAWINGS

FIG. 1 is an elevational view of an injection molding pin according to a preferred embodiment of the present invention;

FIG. 2 is a partial sectioned side view of the invention of FIG. 1 illustrating the shaft member in its extended position;

FIG. 3 is a partial sectioned side view of the invention of FIG. 1 illustrating the shaft member in its retracted position;

FIG. 4 is an exploded view of the invention of FIG. 1;

FIG. 5 is an end view of the invention of FIG. 1.

### DETAILED DESCRIPTION

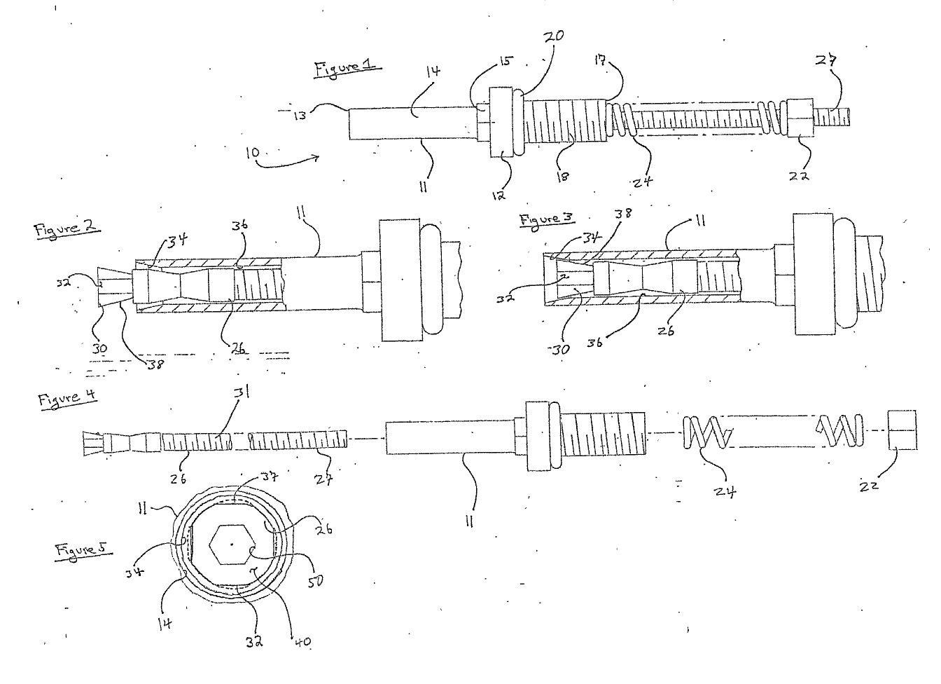

Referring to FIG. 1, there is shown a pin 10 according to a preferred constructed embodiment of the present invention. Pin 10 has a preferably metallic pin body 11 with a first end 13 and a second end 17. In the preferred embodiment, pin 10 is used to both deliver and withdraw compressible and non-compressible pressurized fluids to a mold cavity of a fluid-assisted injection molding apparatus. Pin 10 may serve as the sole source of pressurized fluid for an injection molding cavity, or it may be accompanied by one or more other pins, depending on the application. Pin body 11 is hollow and includes a preferably cylindrical extension portion 14 and a threaded base portion 18. Pin body 11 also preferably includes a central collar 12, which is disc-shaped, and a polygonal grip 15. A wrench, pliers, or similar appropriate tool may be positioned to bear against polygonal grip 15, and rotated to screw pin body 11 into a threaded fixture in a housing for an injection mold apparatus (not shown). Alternatively, collar 12 itself might be designed having a polygonal cross section, and could serve as the feature used to secure pin 10 to the housing. Pin 10 is thus secured to the housing at its base 18, with extension portion 14 protruding into the mold cavity (not shown). As pin body 11 is screwed into its fixture, an O-ring 20, which is preferably positioned adjacent collar 12, is compressed against the housing, creating a fluid-tight seal in a conventional manner. It should be appreciated that some other method of securing pin 10 to a housing might be used without departing from the scope of the present invention. For example, pin body 11 might be inserted through a bore in the housing, and a nut screwed to base 18, securing pin body 11 to the housing and creating a fluid-tight seal at O-ring 20.

Referring in addition to FIGS. 2-4, a shaft member 26 is provided and is positioned partially within the interior of hollow pin body 11. Shaft member 26 is preferably cylindrical in cross section, however, the dimensions and cross section of shaft member 26 might be varied without departing from the scope of the present invention. Fluid is injected into the associated mold cavity through a passage 36, and may be supplied, for example, via an aperture in base portion 18, or with a supply line coupled directly to base portion 18 at pin body 11's second end 17. Shaft member 26 preferably has a threaded shank portion 27, a textured medial region 31, and a substantially frustoconical tip portion 30. It is believed that the textured, in this example threaded, region 31 increases turbulent flow in fluid passing through passage 36. Increased turbulence, or decreased laminar flow, facilitates ejection of intruding plastic from pin 10. Shaft member 26 is reciprocable between a retracted position at which tip 30 preferably contacts a seat 34, and an extended position at which tip 30 is remote from seat 34. In a preferred embodiment, tip 30 and seat 34 are complementary, however, such a relationship is not critical. Additionally, the conical design of seat 34 and tip 30 is not critical and, for instance, shaft member 26 might include a discoidal/cylindrical or spherical tip rather than a frustoconical tip. Similarly, the geometry of seat 34 might be varied without departing from the scope of the present invention. Pin 10 further provides a spring 24, which is preferably helical, and is positioned about shaft member 26 and at least partially positioned about threaded portion 27. A tensioning member, which is preferably a nut 22, is threadedly received on shank portion 27, and holds spring 24 between the nut and base 18. In a preferred embodiment, nut 22 may be rotated in a first direction, axially traveling relative to shaft member 26 due to their threaded relationship, and compressing spring 24. When nut 22 is rotated in the opposite direction, it allows spring 24 to decompress. When compressed, i.e. energized, spring 24 thus biases nut 22, and thereby biases shaft member 26, toward its retracted position. As is well known in the art, the resistive force of a conventional spring increases with the degree of compression. Because rotation of nut 22 about shaft member 26 alternately compresses and decompresses spring 24, the biasing force provided by spring 24 may be adjusted simply by rotating nut 22. In a related embodiment, shaft member 26 may be rotated while nut 22 is held stationary, producing a similar result. Referring to FIG. 5, which is an end view of pin 10 illustrating shaft member 26 in its retracted position, shaft member 26 includes a shaped recess 50 located in its end face. An appropriate tool such as an Allen wrench, screwdriver, or torx driver may be inserted into recess 50 and rotated, simultaneously rotating shaft member 26 relative to nut 22 to adjust the biasing force. In this embodiment, nut 22 is secured to a portion of the mold housing (not shown), or may alternatively be secured to spring 24 or otherwise immobilized relative to shaft member 26.

Tip portion 30 has a plurality of beveled surfaces 32, preferably four, positioned radially around tip portion 30. When shaft member 26 is in its retracted position, with tip portion 30 resting against seat 34, beveled surface 32 partially define a plurality of apertures 37 which allow continuous fluid communication between the mold cavity and fluid passage 36 when shaft member 26 is retracted. Stated another way, with shaft member 26 in this position, tip portion 30 and seat 34 define a positive fluid flow area. It should be appreciated that the present invention is not limited to the disclosed geometry of the tip portion 30 and seat 34. For instance, rather than a frustoconical tip portion, a flattened discoidal tip, or even a substantially spherical tip portion might be used. Rather than machining bevels on the tip portion to provide for continuous fluid communication between passage 36 and the mold cavity, bevels, grooves, or other reduced regions might be machined in the seat itself to allow fluid flow when shaft member 26 is retracted. A bore through the tip, or even through the entire length of shaft member 26 could be used to provide continuous fluid communication between the mold cavity and the fluid supply without departing from the scope of the present invention. Thus, pin 10 provides an “always-on” feature wherein regardless of the selected tip design, there is continuous fluid communication between fluid passage 26 and the mold cavity. Because there is preferably continuous fluid communication, initiation of fluid injection can take place even when plastic covers or otherwise blocks the outlet of pin 10. With the pin retracted, the relatively small outlets past tip portion 30 allow fluid to be ejected past the tip with a relatively high velocity. Thus, when the pin is retracted and covered with plastic, the always-on feature allows fluid to be forced at relatively high pressure out of pin 10, clearing away plastic and initiating the development of an internal cavity in the molded part. In addition, the always-on feature allows fluid to be withdrawn from the mold without actuating the pin. Tip portion 30 includes at least one pressure surface 38, which includes the beveled regions 32, and is exposed to fluid pressure from passage 36. In shaft member 26's extended position (illustrated in FIG. 2), tip portion 30 is lifted from seat 34, and the fluid flow area is thus greater than in shaft member 26's retracted position. Therefore, once sufficient fluid pressure is supplied, the fluid acting on pressure surface(s) 28 forces an extension of shaft member 26 beyond the discharge end 13 of pin 10, pushing plastic away from the end of the pin. In embodiments wherein the pressurized fluid is recirculated or exhausted via the delivery pin, the beveled regions 32 (or other orifices, as described herein) allow fluid to exit through pin 10, without the need for a separate valving system in the mold. In varying the tin design, it should be appreciated that different tip shapes will exhibit different flow characteristics. Similarly, the fluid pressure acting on pressure surface 38 will have a different resultant force on shaft member 26 in frustoconical versus flattened or spherical tip designs. A related concern is the appropriate strength of biasing spring 24, which would also vary with changes in tip design.

When a typical fluid assisted injection mold cycle begins, injection of the desired quantity of molten plastic into the mold cavity is initiated. Shortly before the initiation of fluid injection is desired, the pressurized fluid supply (not shown) is connected/turned on, and fluid begins to flow to passage 36. Because passage 36 preferably occupies the clearance between shaft member 26 and the interior of pin body 10, fluid may be delivered to passage 36 at second end 17. For example, a fluid supply line (not shown) may be positioned around second end 17 with a fluid-tight seal, or second end 17 may be positioned to extend into a sealed fluid delivery cavity. Alternatively, a fluid supply line might be connected to passage 36 via a bore through the side of pin body 10. In any event, it should be appreciated that injection of both compressible and non-compressible fluids into a mold cavity with the present invention is contemplated. With the delivery of pressurized fluid to passage 36, there is an almost immediate increase in the fluid pressure in the region of first end 13. Because the orifices defined by bevels 32 are in continuous fluid communication with the mold cavity, fluid begins to flow into the mold cavity as soon as it reaches first end 13, so long as there is sufficient fluid pressure to displace plastic in the mold. When sufficient delivery pressure is reached, fluid, for example pressurized nitrogen or water, is injected via pin 10 and forces the molten plastic toward the outer surfaces of the mold. Because pressure surface 38 is exposed to fluid pressure from passage 36, the fluid pressure acts on surface(s) 38 with an opening force. Where fluid is supplied with sufficient pressure, the opening force on tip portion 30 overcomes the initial biasing force of spring 24, and urges shaft member 26 toward its extended position. As spring 24 is compressed, its biasing force acting on shaft member 26 via nut 22 increases. When the biasing force from spring 24 and the opening force on surface 38 are substantially equal, shaft member 26 is balanced, and ceases moving, while fluid continues to be injected via pin 10 into the mold cavity. As the fluid pressure in the mold cavity approaches that of the fluid supply pressure, the amount of fluid flowing through pin 10 decreases, as does the opening hydraulic/pneumatic force acting on tip portion 30. Consequently, shaft member 26 begins to move toward its seated position under the influence of spring 24. Fluid supply typically continues until the plastic has been forced to the outer surfaces of the mold, and hardened sufficiently to resist sagging when the internal mold cavity pressure drops. When the plastic has hardened sufficiently, the pressurized fluid may be withdrawn from the cavity through apertures 37 of pin 10 (or through another fluid exhaust outlet), the molded plastic item removed, and the cycle repeated.

During the injection molding cycle, plastic may adhere to pin body 11, potentially packing the region around tip portion 30 sufficiently to prevent proper delivery of pressurized fluid when the next injection cycle begins. In the described injection cycle, tip portion 30 is forced away from seat 34, and preferably past first end 13, pushing any undesirable hardened plastic from pin body 11 which would interfere with proper fluid delivery. Because nut 22 is rotatable to increase or decrease the compression, and thus biasing force, of spring 24, the force necessary to lift shaft member 26 from its seated position can be adjusted. Accordingly, the distance shaft member 26 travels between its retracted and extended positions at a given fluid supply pressure can be adjusted. This feature allows an operator to optimize the self-cleaning feature of pin 10 by adjusting the reciprocation distance, necessary fluid pressure, and timing to best remove intruding plastic, depending on operating conditions. In one embodiment, the shaped recess 50 allows shaft member 26 to be rotated manually to adjust the tension on spring 24, and is accessible from the mold cavity. In such an embodiment, nut 22 is preferably rotatably fixed relative to pin 10 and/or the mold housing, although once spring 24 is compressed, the frictional interaction between spring 24 and nut 22 can be sufficient to prevent nut 22 from rotating when shaft member 26 is rotated to adjust the biasing force. In alternative embodiments, nut 22 may itself be rotated to either compress or decompress spring 24. Thus, the present invention provides a fluid injection pin that is self-cleaning. In earlier designs, it was necessary to disassemble the mold apparatus and pin, manually removing the plastic intrusions. In the present invention, however, the reciprocation of shaft member 26 drives plastic out of the end of the pin automatically, substantially reducing downtime and labor previously required to clean the pins.

The foregoing description is intended for illustrative purposes only and should not be construed to limit the scope of the present invention in any way. Rather than the disclosed geometry of the tip portion, different designs might be employed, as described above. Rather than a cylindrical shaft member, a shaft member having, for example, a triangular or rectangular cross section could be used. Further, the means by which pin 10 is attached to the mold apparatus might be varied. Thus, those skilled in the art will appreciate that these and other modifications might be made to the presently disclosed embodiments without departing from the intended spirit and scope of the present invention. Other aspects, features, and advantages of the present invention will be apparent upon an examination of the attached drawing figures and appended claims.

What is claimed is:

1. A pin for a fluid assisted injection molding apparatus comprising:
a pin body defining a longitudinal fluid passage and a seat;
a shaft member in said fluid passage and reciprocable between an extended position and a retracted position, said shaft member and said seat defining at least one fluid orifice at said retracted position for fluid passage therethrough.

2. The pin of claim 1 further comprising:
an adjustable tensioning member about said shaft member;
a biasing member abutting said pin body and said tensioning member, wherein rotating said shaft member relative to said tensioning member adjusts a biasing force on said shaft member.

3. The pin of claim 1 wherein said shaft member includes a tip portion received in said seat in a substantially mating relationship, wherein said tip portion and said seat each partially define a plurality of orifices fluidly connected with said fluid passage.

4. The pin of claim 2 further comprising an enlarged base; and wherein
said tensioning member is a nut threadedly received on said shaft member;
said biasing member is a helical spring adjacent said nut and adjacent said enlarged base.

5. A pin for a fluid assisted injection molding apparatus comprising:
a pin body defining a fluid passage;
a shaft member positioned at least partially within said pin body, said shaft member reciprocable between an extended position and a retracted position at which said shaft member at least partially defines a positive flow area fluidly connected to said fluid passage;
biasing means for biasing said shaft member toward said retracted position, said biasing means adjustable to increase or decrease a biasing force on said shaft member.

6. The pin of claim 5, said shaft member further comprising a substantially frustoconical tip portion received in a substantially complementary seat defined by said pin body.

7. The pin of claim 6 wherein said tip portion includes at least one beveled region, said at least one beveled region partially defining an orifice when said shaft member is at said retracted position.

8. The pin of claim 6 wherein said seat is characterized by at least one reduced region, said at least one reduced region partially defining an aperture when said shaft member is at said retracted position.

9. The pin of claim 6 further comprising reciprocating means for said shaft member, said reciprocating means selected from the group consisting of electromagnetic, hydraulic, and pneumatic actuators.

10. An injection molding apparatus comprising:
a mold body defining a mold cavity for forming a part;
a source of fluent plastic connected to said mold cavity;
a pressurized fluid system for delivery and evacuation of pressurized fluid from said mold cavity;
at least one fluid injection pin operable to fluidly connect said pressurized fluid system to said mold cavity, said pin comprising a pin body defining a fluid passage and a shaft member reciprocable in said fluid passage, and further comprising adjustable biasing means for biasing said shaft member toward said retracted position.

11. The injection molding apparatus of claim 10, said shaft member including an enlarged tip portion that at least partially blocks said fluid passage when said shaft member is at said retracted position; and wherein
said enlarged tip portion at least partially defines a fluid aperture fluidly connecting said pressurized fluid system to said mold cavity when said shaft member is at said retracted position.

12. The injection molding apparatus of claim 11 wherein said enlarged tip portion is substantially frustoconical.

13. The injection molding apparatus of claim 10 wherein said enlarged tip portion is substantially cylindrical.

14. The injection molding apparatus of claim 10 wherein said adjustable biasing means comprises a tensioning member threadedly received on said shaft member, said shaft member and said tensioning member rotatable relative to one other in a first direction to energize a biasing member, and rotatable relative to one another in a second direction to de-energize said biasing member.

15. A pin for a fluid assisted injection molding apparatus comprising:
a hollow pin body;
a shaft member having a threaded shank and reciprocable in said pin body between an extended position and a retracted position, said shaft member biased toward said retracted position with a biasing spring having an adjustable biasing force;
tensioning means rotatable in first and second directions relative to said pin body to increase and decrease said biasing force, respectively.

16. The pin of claim 15, said tensioning means comprising a tensioning member threadedly received on said threaded shank and a biasing spring; wherein
rotation of said tensioning member in a first direction compresses said biasing spring, and rotation of said tensioning member in a second direction decompresses said biasing spring.

17. The pin of claim 15 wherein said tensioning means comprises a tensioning member fixed relative to said pin body and a biasing spring, said tensioning member threadedly received on said threaded shank; wherein
rotation of said shaft member relative to said tensioning member threadedly urges said tensioning member axially relative to said pin body to compress or decompress a biasing spring.

18. A pin for a fluid assisted injection molding apparatus comprising:
a pin body having an outlet;
a shaft member reciprocable in said pin body between a retracted and an extended position, said shaft member having a tip with a shaped recess;
a tensioning member threadedly received on said shaft member;
a biasing member abutting said pin body and abutting said tensioning member and biasing said shaft member toward said retracted position; wherein
said shaft member is rotatable relative to said tensioning member in alternate directions, said shaped recess facilitating rotational manipulation thereof with a complementary tool.

19. The pin of claim 18 wherein said tensioning member is fixed relative to said pin.

20. The pin of claim 18 wherein said shaped recess is polyangular.
